(19) United States
(12) Patent Application Publication
(10) Pub. No.: US 2023/0327249 A1
(43) Pub. Date: Oct. 12, 2023

(54) BATTERY CELL GROUPING SOLUTIONS FOR TRACTION BATTERY PACKS THAT INCLUDE CELL-TO-PACK BATTERY SYSTEMS

(71) Applicant: FORD GLOBAL TECHNOLOGIES, LLC, Dearborn, MI (US)

(72) Inventors: Patrick Daniel MAGUIRE, Ann Arbor, MI (US); Che-Chun CHANG, Ann Arbor, MI (US); Marc DUGAS, Wixom, MI (US)

(21) Appl. No.: 17/894,514

(22) Filed: Aug. 24, 2022

Related U.S. Application Data
(60) Provisional application No. 63/322,766, filed on Mar. 23, 2022.

(51) Int. Cl. B60L 50/64; H01M 50/204; H01M 10/04; H01M 50/262

(52) U.S. Cl. CPC H01M 50/204; B60L 50/64; H01M 10/0481; H01M 50/262; H01M 2220/20

(57) ABSTRACT

Battery cell grouping solutions are disclosed for assembling traction battery packs that include cell-to-pack battery systems. A cell grouping assembly may be utilized to establish a common datum reference plane relative to multiple groupings of battery cells. An exemplary assembly method may include positioning the groupings of battery cells relative to the cell grouping assembly, and then applying a compressive force to the groupings of battery cells to provide cell stacks of the cell-to-pack battery system. The grouped cell stacks may then be located to an enclosure tray of the traction battery pack.

### CROSS REFERENCE TO RELATED APPLICATIONS

This disclosure claims priority to U.S. Provisional Application No. 63/322,766, which was filed on Mar. 23, 2022 and is incorporated herein by reference.

### TECHNICAL FIELD

This disclosure relates generally to traction battery packs, and more particularly to systems and methods for assembling traction battery packs that include cell-to-pack battery systems.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack can power the electric machines and other electrical loads of the vehicle.

Conventional traction battery packs include groupings of battery cells called battery arrays. The battery arrays include various array support structures (e.g., array frames, spacers, rails, walls, end plates, bindings, etc.) that are arranged for grouping and supporting the battery cells in multiple individual units inside the traction battery pack enclosure.

### SUMMARY

A traction battery pack according to an exemplary aspect of the present disclosure includes, among other things, an enclosure assembly and a cell-to-pack battery system housed within the enclosure assembly and including a first cell stack, a second cell stack, and a cell grouping assembly. The cell grouping assembly establishes a common datum reference plane for aligning a first grouping of battery cells of the first cell stack and a second grouping of battery cells of the second cell stack relative to the cell grouping assembly.

In a further non-limiting embodiment of the foregoing traction battery pack, the first cell stack establishes a first cell row of a cell matrix of the cell-to-pack battery system, and the second cell stack establishes a second cell row of the cell matrix.

In a further non-limiting embodiment of either of the foregoing traction battery packs, an enclosure tray of the enclosure assembly provides a cell-compressing opening for compressing the cell matrix.

In a further non-limiting embodiment of any of the foregoing traction battery packs, the cell grouping assembly includes a first end wall, a second end wall, and a transverse beam extending between the first end wall and the second end wall.

In a further non-limiting embodiment of any of the foregoing traction battery packs, the first grouping of battery cells is aligned relative to a first side of the transverse beam, and the second grouping of battery cells is aligned relative to a second side of the transverse beam.

In a further non-limiting embodiment of any of the foregoing traction battery packs, the first and second end walls are metallic structures, and the transverse beam is a polymeric structure.

In a further non-limiting embodiment of any of the foregoing traction battery packs, an opening is formed through the first end wall or the second end wall. The opening is configured to receive a compression device or a fastener.

In a further non-limiting embodiment of any of the foregoing traction battery packs, a structural adhesive is applied between the first cell stack and the cell grouping assembly.

In a further non-limiting embodiment of any of the foregoing traction battery packs, the cell-to-pack battery system includes a third cell stack, a fourth cell stack, and a second cell grouping assembly. The second cell grouping assembly establishes an additional common datum reference plane for aligning a third grouping of battery cells of the third cell stack and a fourth grouping of battery cells of the fourth cell stack relative to the second cell grouping assembly.

In a further non-limiting embodiment of any of the foregoing traction battery packs, the second cell grouping assembly is positioned to abut against the cell grouping assembly.

A method for assembling a traction battery pack according to another exemplary aspect of the present disclosure includes, among other things, arranging a first grouping of battery cells relative to a first side of a cell grouping assembly, and arranging a second grouping of battery cells relative to a second side of the cell grouping assembly. The first grouping of battery cells, the second grouping of battery cells, and the cell grouping assembly establish part of a cell-to-pack battery system of the traction battery pack.

In a further non-limiting embodiment of the foregoing method, the method includes, after the arranging, applying a compressive force to the first and second groupings of battery cells via the cell grouping assembly.

In a further non-limiting embodiment of either of the foregoing methods, the method includes, after the applying, locating the cell-to-pack battery system within a cell-compressing opening of an enclosure tray of the traction battery pack.

In a further non-limiting embodiment of any of the foregoing methods, the method includes, after the applying, fixating a transverse member of the cell grouping assembly from movement relative to at least one end wall of the cell grouping assembly.

In a further non-limiting embodiment of any of the forgoing methods, the first side of the cell grouping assembly establishes a first common datum reference plane for aligning the first grouping of battery cells, and the second side of the cell grouping assembly establishes a second common datum reference plane for aligning the second grouping of battery cells.

In a further non-limiting embodiment of any of the forgoing methods, the method includes, prior to the arranging, positioning the first grouping of battery cells atop a flat surface.

In a further non-limiting embodiment of any of the forgoing methods, the flat surface establishes a third common datum reference plane for aligning the first grouping of battery cells.

In a further non-limiting embodiment of any of the forgoing methods, the method includes arranging a third grouping of battery cells relative to a first side of a second cell grouping assembly, and arranging a fourth grouping of battery cells relative to a second side of the second cell grouping assembly.

In a further non-limiting embodiment of any of the forgoing methods, the method includes positioning the second cell grouping assembly to abut against the cell grouping assembly.

In a further non-limiting embodiment of any of the forgoing methods, the method includes bonding the first grouping of battery cells to the first side and the second grouping of battery cells to the second side.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell-to-pack battery system of the traction battery pack of FIG. 2.

FIGS. 4, 5, 6, 7, and 8 schematically illustrate a method for grouping battery cells together as part of a manufacturing process for assembling a cell-to-pack battery system of a traction battery pack.

### DETAILED DESCRIPTION

This disclosure details battery cell grouping solutions for assembling traction battery packs that include cell-to-pack battery systems. A cell grouping assembly may be utilized to establish a common datum reference plane relative to multiple groupings of battery cells. An exemplary assembly method may include positioning the groupings of battery cells relative to the cell grouping assembly, and then applying a compressive force to the groupings of battery cells to provide cell stacks of the cell-to-pack battery system. The grouped cell stacks may then be located to an enclosure tray of the traction battery pack. These and other features are discussed in greater detail in the following paragraphs of this detailed description.

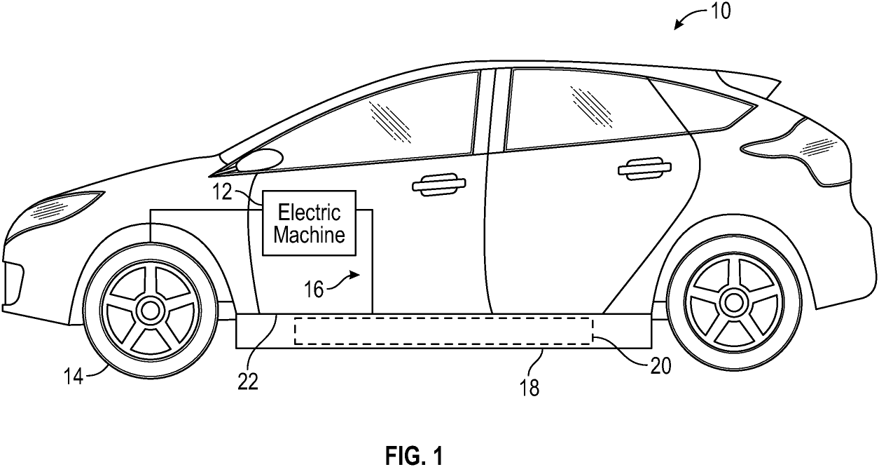

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV’s), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In an embodiment, the electrified vehicle 10 is a car. However, the electrified vehicle 10 could alternatively be a pickup truck, a van, a sport utility vehicle (SUV), or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more drive wheels 14 of the electrified vehicle 10.

A voltage bus 16 may electrically couple the electric machine 12 to a traction battery pack 18. The traction battery pack 18 is capable of outputting electrical power to power the electric machine 12 and/or other electrical loads of the electrified vehicle 10.

The traction battery pack 18 may be secured to an underbody 22 of the electrified vehicle 10. However, the traction battery pack 18 could be located elsewhere on the electrified vehicle 10 within the scope of this disclosure.

The traction battery pack 18 is an exemplary electrified vehicle battery. The traction battery pack 18 may be a high voltage traction battery pack that includes a cell-to-pack battery system 20. Unlike conventional traction battery pack battery systems, the cell-to-pack battery system 20 incorporates battery cells or other energy storage devices without the cells being arranged in individual arrays or modules inside the batter enclosure. The cell-to-pack battery system 20 therefore eliminates most if not all the array support structures (e.g., array frames, spacers, rails, walls, end plates, bindings, etc.) necessary for grouping the battery cells into the arrays/modules. Further, the cell-to-pack battery system 20 may provide the total high voltage bus electrical potential of the traction battery pack 18 with a single battery unit as opposed to conventional battery systems that require multiple individual battery arrays/modules that must be connected together after being positioned within the battery enclosure for achieving the total high voltage electrical potential.

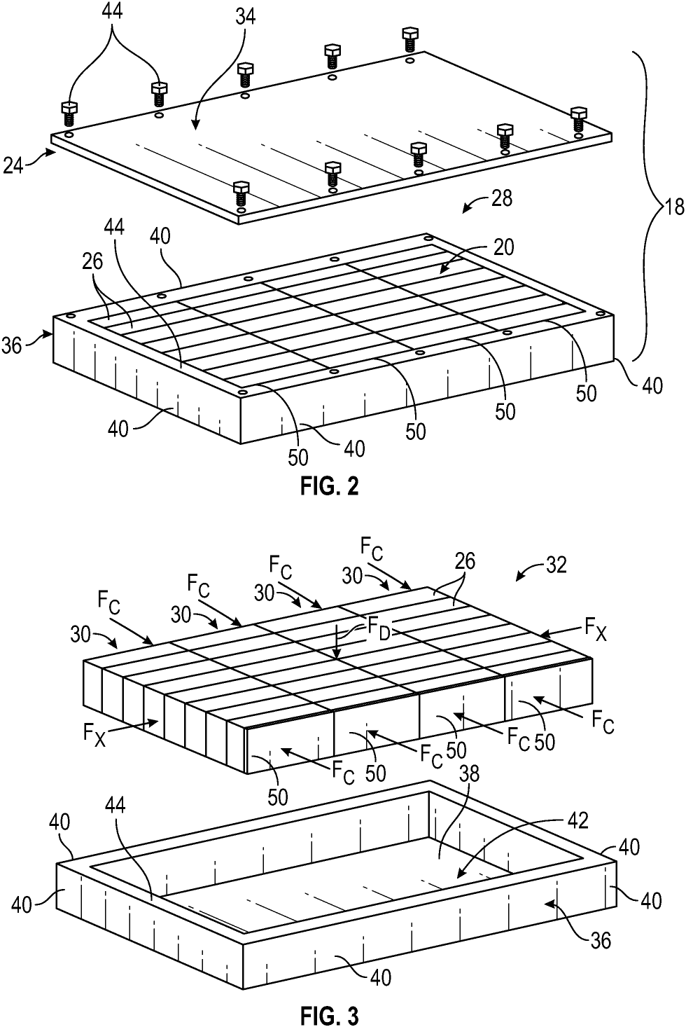

Referring now to FIGS. 2 and 3, the traction battery pack 18 may include an enclosure assembly 24 that is arranged for housing the cell-to-pack battery system 20. In an embodiment, the cell-to-pack battery system 20 includes a plurality of battery cells 26 that are held within an interior area 28 established by the enclosure assembly 24.

The battery cells 26 may supply electrical power to various components of the electrified vehicle 10. The battery cells 26 may be stacked side-by-side relative to one another to construct a cell stack 30, and the cell stacks 30 may be positioned side-by-side in rows to provide a cell matrix 32.

In an embodiment, each cell stack 30 includes eight individual battery cells 26, and the cell matrix 32 includes four cell stacks 30 for a total of thirty-two battery cells 26. Providing an even quantity of battery cells 26 and an even quantity of cell stacks 30 can help to support an efficient electrical bussing arrangement. Although a specific number of battery cells 26 and cells stacks 30 are illustrated in the various figures of this disclosure, the cell-to-pack battery system 20 of the traction battery pack 18 could include any number of battery cells 26 and any number of cell stacks 30. In other words, this disclosure is not limited to the exemplary configuration shown in FIGS. 2 and 3.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure assembly 24 of the traction battery pack 18 may include an enclosure cover 34 and an enclosure tray 36. The enclosure cover 34 may be secured to the enclosure tray 36 to provide the interior area 28 for housing the cell-to-pack battery system 20.

The enclosure tray 36 may include a floor 38 and a plurality of side walls 40 arranged relative to one another to provide a cell-compressing opening 42. The floor 38 and the side walls 40 may be mechanically coupled to one another, such as by welding, for example.

During assembly of the traction battery pack 18, the enclosure cover 34 may be secured to the enclosure tray 36 at an interface 44 that substantially circumscribes the interior area 28. In some implementations, mechanical fasteners 46 may be used to secure the enclosure cover 34 to the enclosure tray 36, although other fastening methodologies (adhesion, etc.) could also be suitable.

The cell matrix 32 of the cell-to-pack battery system 20 may be positioned within the cell-compressing opening 42 provided by the enclosure tray 36. The exemplary enclosure tray 36 is depicted as including a single cell-compressing opening 42, however it should be understood that this disclosure extends to structural assemblies that provide one or more cell-compressing openings. The enclosure cover 34 may cover the cell matrix 32 within the cell-compressing opening 42 to substantially surround the battery cells 26 on all sides. Once fully assembled and positioned relative to the enclosure tray 36, the cell matrix 32 may establish a single battery unit capable of providing the total high voltage bus electrical potential of the traction battery pack 18.

The enclosure tray 36 may compress and hold the cell matrix 32 when the cell matrix 32 is received within the cell-compressing opening 42. In an embodiment, the side walls 40 of the enclosure tray 36 apply forces to the cell matrix 32 when the cell matrix 32 is positioned within the cell-compressing opening 42.

In an embodiment, in order to insert the cell matrix 32 into the cell-compressing opening 42, the cell matrix 32 may first be compressed, and then, while compressed, moved into place in the cell-compressing opening 42. A compressive force F_{C} may be applied to opposed ends of one of the cell stacks 30. The compressive force F_{C} essentially squeezes the battery cells 26 within the cell stack 30, thereby compressing the cell stack 30 and the individual battery cells 26 to a reduced thickness. While the compressive force F_{C} is applied to the cell stack 30, the cell stack 30 may be inserted into a respective cell-compressing opening 42 by a downward force F_{D}. The downward force F_{D} may be applied directly to one or more of the battery cells 26.

While the term “downward” is used herein to describe the downward force F_{D}, it should be understood that the term “downward” is used herein to refer to all forces tending to press a cell stack 30 into a cell compressing opening 42. In particular, the term “downward” refers to all forces substantially perpendicular to the compressive force F_{C}, whether or not the force is truly in a “downward” direction. For example, this disclosure extends to cell stacks that are compressed and inserted into a cell-compressing opening in a sideways direction.

The cell stacks 30 could be individually compressed and inserted into the cell-compressing opening 42. In another embodiment, the entire cell matrix 32 is compressed and inserted into the cell-compressing opening 42. As schematically shown in FIG. 3, in such an embodiment, additional compressive forces Fx can compress the cell stacks 30 together for insertion of the cell matrix 32 into the cell-compressing opening 42. The compressive forces F_{X} are generally perpendicular to the compressive forces F_{C}. The compressive forces F_{X} may be applied together with the compressive forces F_{C}. The force F_{D} may then be applied to move the entire cell matrix 32 into the cell-compressing opening 42.

In an embodiment, an entire perimeter of the cell-compressing opening 42 is defined by the side walls 40 of the enclosure tray 36. The side walls 40 can apply a compressive force to the battery cells 26 about the entire perimeter of the cell matrix 32. The side walls 40 may therefore function as a rigid halo-type structure that compresses and tightly holds the cell matrix 32.

The configuration described above is considered to be a cell-to-pack type battery pack, which differs from conventional battery pack types that include enclosures holding arrays of battery cells enclosed by array support structures that are spaced apart from walls of a battery enclosure, and where the battery enclosure does not apply compressive forces to any of the battery cells. The cell-to-pack type battery pack described herein also eliminates the rigid cross members that are commonly secured to the enclosure tray of conventional traction battery backs for providing mounting points for securing the battery arrays and the enclosure cover.

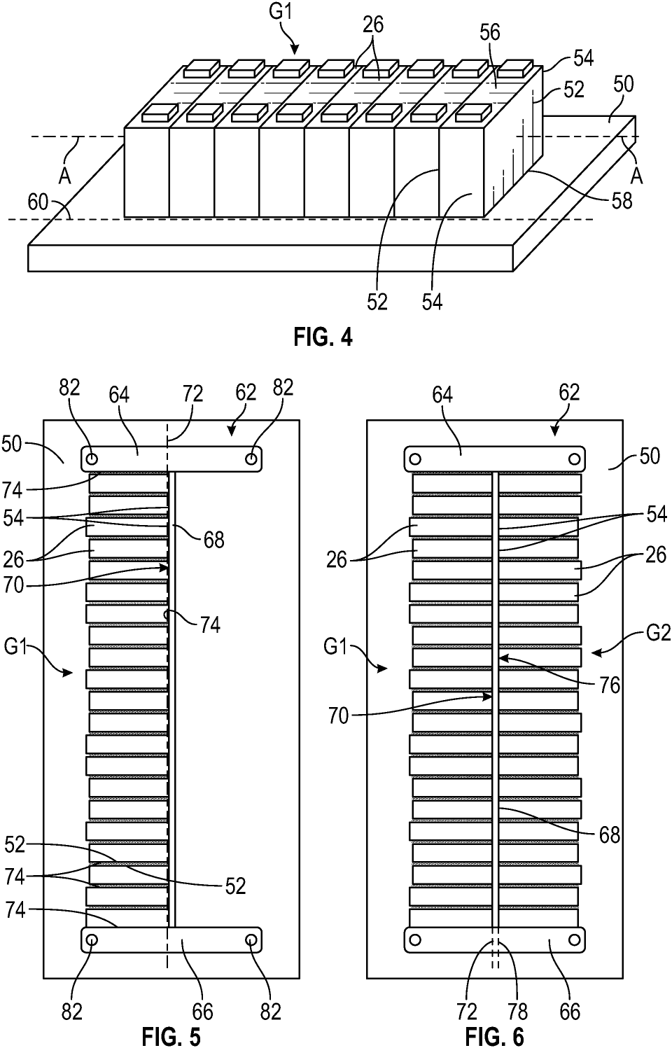

FIGS. 4-8, with continued reference to FIGS. 1-3, schematically illustrate a method for assembling the traction battery pack 18, and in particular for grouping battery cells 26 together to form the cell stacks 30 of the cell-to-pack battery system 20. The method may include a greater or fewer number of steps than recited below, and the exact order of the steps is not intended to limit this disclosure.

Referring first to FIG. 4, a first grouping G1 of battery cells 26 may be positioned atop a flat surface 50. The battery cells 26 may be arranged side-by-side along a cell stack axis A to establish one of the cells stacks 30 of the cell-to-pack battery system 20. Each battery cell 26 may include major sides 52, minor sides 54, a top side 56, and a bottom side 58. In an embodiment, the bottom side 58 of each battery cell 26 is positioned in contact with the flat surface 50. However, any surface of the battery cells 26 could be arranged relative to the flat surface 50.

The flat surface 50 may be part of an assembly pallet or some other structure associated with a workstation of a manufacturing assembly line. The flat surface 50 may establish a first common datum reference plane 60 for aligning and grouping the battery cells 26 relative to one another. Thus, in this embodiment, the bottom side 58 of each battery cell 26 is aligned relative to the first common datum reference plane 60.

Next, as shown in FIG. 5, the first grouping G1 of battery cells 26 may be moved into position relative to a cell grouping assembly 62. The cell grouping assembly 62 may be positioned against the flat surface 50 either before or after positioning the first grouping G1 of battery cells 26 atop the flat surface 50. The cell grouping assembly 62 may include a first end wall 64, a second end wall 66, and a transverse beam 68 extending between the first end wall 64 and the second end wall 66. The transverse beam 68 may be configured to move axially relative to the first end wall 64, the second end wall 66, or both. In an embodiment, the first end wall 64 and the second end wall 66 are metallic structures, and the transverse beam 68 is a polymeric structure. However, the exact material make-up of each subcomponent of the cell grouping assembly 62 is not intended to limit this disclosure.

The battery cells 26 or the cell grouping assembly 62 may be moved such that one of the minor sides 54 of each battery cell 26 is arranged to contact a first side 70 of the transverse beam 68. The first side 70 of the transverse beam 68 may establish a second common datum reference plane 72 for aligning and grouping the battery cells 26 relative to one another in order to establish one of the cell stacks 30. The first and second common datum reference plane 60, 72 may be beneficial as assembly aids when the battery cells 26 have slightly different sizes due to tolerance stack ups and other manufacturing complexities. As schematically depicted, any tolerance variations of the battery cells 26 are therefore directed away from the first side 70 of the transverse beam 68.

The battery cells 26 may be bonded together during this phase of the method by applying a structural adhesive 74. The structural adhesive 74 may be applied between the minor sides 54 and the first side 70 of the transverse beam 68, between the battery cells 26 located at the ends of the first grouping G1 and each end wall 64, 66 of the cell grouping assembly 62, and/or between the major sides 52 of neighboring battery cells 26. Once cured, the structural adhesive 74 can stiffen the cell stack 30, thereby preventing drooping and/or buckling or otherwise distorting. The structural adhesive 74 may be an epoxy or any other suitable adhesive.

Referring now to FIG. 6, a second grouping G2 of battery cells 26 may be moved into position relative to both the flat surface 50 and the cell grouping assembly 62. The second grouping G2 of battery cells 26 may establish an additional cell stack 30 of the cell-to-pack battery system 20. The second grouping G2 of battery cells 26 may be moved such that the bottom sides 58 of the battery cell 26 are arranged to contact the flat surface 50 and one of the minor sides 54 of each battery cell 26 are arranged to contact a second side 76 of the transverse beam 68. The second side 76 is an opposite side from the first side 70 of the transverse beam 68. The second side 76 may establish a third common datum reference plane 78 for aligning and grouping the battery cells 26 of the second grouping G2 relative to one another in order to establish another one of the cell stacks 30. The third common datum reference plane 78 is parallel to the second common datum reference plane 78. The cell grouping assembly 62 is therefore capable of providing datum reference points that are referenced against at least two sides (e.g., bottom and minor side) of each cell stack 30 positioned thereto.

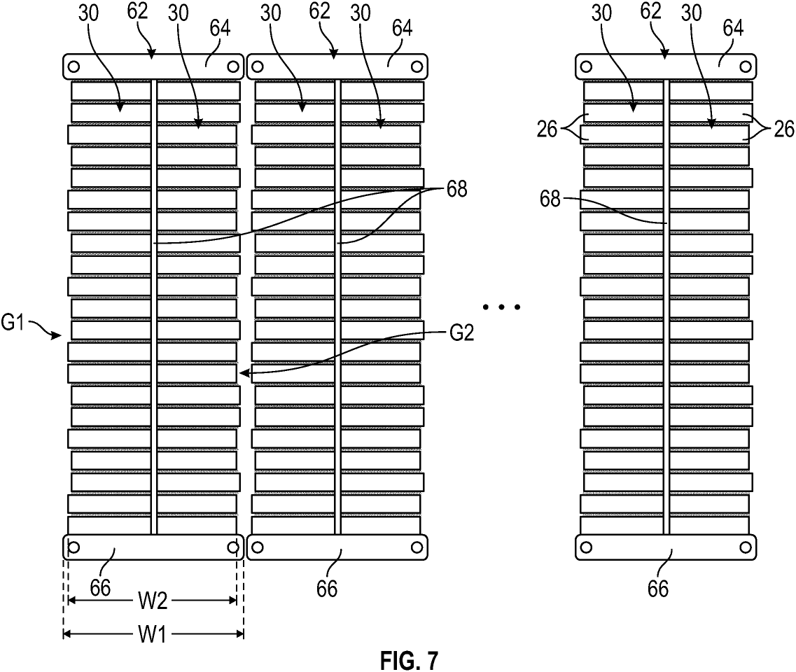

Referring to FIG. 7, the method steps schematically illustrated in FIGS. 4, 5, and 6 may be repeated in order to provide a desired number of cell stacks 30. The cell grouping assemblies 62 utilized to stage a desired number of cell stacks 30 to be utilized within the cell-to-pack battery system 20 may be arranged side-by-side with one another so that the first and second end walls 64, 66 of neighboring cell grouping assemblies 62 abut one another. A width W1 of the first and second end walls 64, 66 of each cell grouping assembly 62 may be slightly larger than a width W2 that spans from one side of the first grouping G1 of battery cells 26 to an opposite side of the second grouping G2 of battery cells 26 that are arranged relative to the cell grouping assembly 62. Therefore, when the cell grouping assemblies 62 are abutted up against one another, the battery cells 26 that are held within neighboring cell grouping assemblies 62 do not interfere with one another.

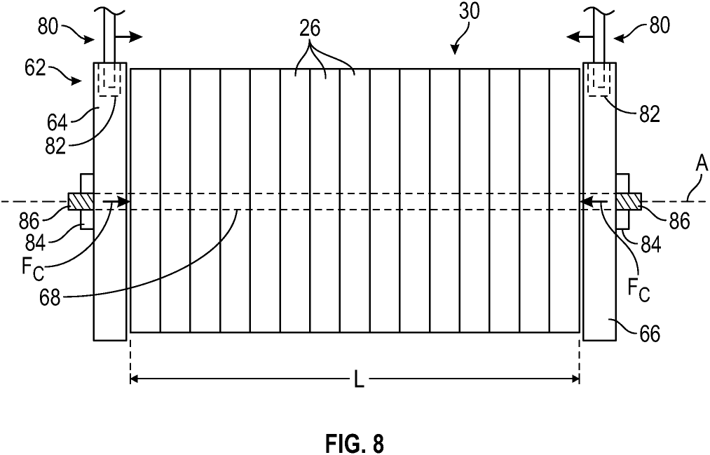

Referring now to FIG. 8, the method may next proceed by exerting compressive forces F_{C} to each cell stack 30. A compression device 80 may be positioned within openings 82 formed in each of the end walls 64, 66 of the cell grouping assembly 62. The openings 82 may additionally be configured to receive fasteners for mounting the cell grouping assemblies 62 to the enclosure tray 36. The compression devices 80 may be moved toward one another to exert the compressive forces F_{C} along each cell stack axis A to the opposed ends of each grouping of battery cells 26 that are held within the cell grouping assembly 62. The compressive forces F_{C} essentially squeeze the battery cells 26 within each cell stack 30, thereby compressing the cell stack 30 and the individual battery cells 26 to a desired cell stack length L.

In an embodiment, the compressive forces F_{C} exerted on the battery cells 26 by the compression devices 80 is about 3 kilonewtons. However, the actual compression forces applied can vary depending on the battery cell type, among other factors. In this disclosure, the term “about” means that the expressed quantities or ranges need not be exact but may be approximated and/or larger or smaller, reflecting acceptable tolerances, conversion factors, measurement error, etc.

The compression devices 80 could be driven to apply the compressive force F_{C} by a pneumatic actuator. However, other types of actuators could alternatively be employed for achieving a desired compression load. Moreover, the compression devices 80 can configured to engage one or more cell grouping assemblies 62 at the same time.

The transverse beam 68 may move relative to one or both of the end walls 64, 66 of each cell grouping assembly 62 as the compressive forces F_{C} are applied. Once a desired compressive load is applied across each grouping of battery cells 26, the positioning of the transverse beam 68 may be fixed against further movement. In an embodiment, a nut 84 may be inserted onto a threaded portion 86 of the transverse beam 68 to prevent further movement of the transverse beam 68 relative to one or both of the end walls 64, 66.

After applying the desired compression forces Fc, the cell grouping assemblies 62 (along with the cells stacks 30 held therein) may be moved together as unit into a cell-compressing opening 42 of the enclosure tray 36 in a manner similar to that shown in FIG. 3. Therefore, the cell grouping assemblies 62 establish part of the cell matrix 32 of the cell-to-pack battery system 20 upon completion of the method described above.

The exemplary manufacturing processes described herein provide a methodology for grouping battery cells together to form a cell matrix of a cell-to-pack battery system using one more cell grouping assemblies. The cell grouping assemblies provide solutions to various assembly complexities that can arise as a result of eliminating much of the array support structures associated with conventional traction battery packs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly; and
a cell-to-pack battery system housed within the enclosure assembly and including a first cell stack, a second cell stack, and a cell grouping assembly,
wherein the cell grouping assembly establishes a common datum reference plane for aligning a first grouping of battery cells of the first cell stack and a second grouping of battery cells of the second cell stack relative to the cell grouping assembly.

2. The traction battery pack as recited in claim 1, wherein the first cell stack establishes a first cell row of a cell matrix of the cell-to-pack battery system, and the second cell stack establishes a second cell row of the cell matrix.

3. The traction battery pack as recited in claim 2, wherein an enclosure tray of the enclosure assembly provides a cell-compressing opening for compressing the cell matrix.

4. The traction battery pack as recited in claim 1, wherein the cell grouping assembly includes a first end wall, a second end wall, and a transverse beam extending between the first end wall and the second end wall.

5. The traction battery pack as recited in claim 4, wherein the first grouping of battery cells is aligned relative to a first side of the transverse beam, and the second grouping of battery cells is aligned relative to a second side of the transverse beam.

6. The traction battery pack as recited in claim 4, wherein the first and second end walls are metallic structures and the transverse beam is a polymeric structure.

7. The traction battery pack as recited in claim 4, comprising an opening formed through the first end wall or the second end wall, wherein the opening is configured to receive a compression device or a fastener.

8. The traction battery pack as recited in claim 1, comprising a structural adhesive applied between the first cell stack and the cell grouping assembly.

9. The traction battery pack as recited in claim 1, wherein the cell-to-pack battery system includes a third cell stack, a fourth cell stack, and a second cell grouping assembly, wherein the second cell grouping assembly establishes an additional common datum reference plane for aligning a third grouping of battery cells of the third cell stack and a fourth grouping of battery cells of the fourth cell stack relative to the second cell grouping assembly.

10. The traction battery pack as recited in claim 9, wherein the second cell grouping assembly is positioned to abut against the cell grouping assembly.

11. A method for assembling a traction battery pack, comprising:
arranging a first grouping of battery cells relative to a first side of a cell grouping assembly; and
arranging a second grouping of battery cells relative to a second side of the cell grouping assembly,
wherein the first grouping of battery cells, the second grouping of battery cells, and the cell grouping assembly establish part of a cell-to-pack battery system of the traction battery pack.

12. The method as recited in claim 11, comprising, after the arranging, applying a compressive force to the first and second groupings of battery cells via the cell grouping assembly.

13. The method as recited in claim 12, comprising, after the applying, locating the cell-to-pack battery system within a cell-compressing opening of an enclosure tray of the traction battery pack.

14. The method as recited in claim 12, comprising, after the applying, fixating a transverse member of the cell grouping assembly from movement relative to at least one end wall of the cell grouping assembly.

15. The method as recited in claim 11, wherein the first side of the cell grouping assembly establishes a first common datum reference plane for aligning the first grouping of battery cells, and the second side of the cell grouping assembly establishes a second common datum reference plane for aligning the second grouping of battery cells.

16. The method as recited in claim 15, comprising, prior to the arranging, positioning the first grouping of battery cells atop a flat surface.

17. The method as recited in claim 16, wherein the flat surface establishes a third common datum reference plane for aligning the first grouping of battery cells.

18. The method as recited in claim 11, comprising:
arranging a third grouping of battery cells relative to a first side of a second cell grouping assembly; and
arranging a fourth grouping of battery cells relative to a second side of the second cell grouping assembly.

19. The method as recited in claim 18, comprising positioning the second cell grouping assembly to abut against the cell grouping assembly.

20. The method as recited in claim 11, comprising bonding the first grouping of battery cells to the first side and the second grouping of battery cells to the second side.
